(19) United States
(12) Patent Application Publication
(10) Pub. No.: US 2003/0184882 A1
(43) Pub. Date: Oct. 2, 2003

(54) Variable diaphragm, and confocal scanning microscope

(75) Inventor: Johann Engelhardt, Bad Schoenborn (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Heidelberg GmbH, Mannheim (DE)

(21) Appl. No.: 10/400,605

(22) Filed: Mar. 27, 2003

(30) Foreign Application Priority Data
Mar. 30, 2002 (DE) DE 202 05 079.3

(51) Int. Cl. G02B 9/00; G02B 9/08

(52) U.S. Cl. 359/739; 359/738

(57) ABSTRACT

A variable diaphragm has two diaphragm blades movable relative to one another. The diaphragm blades are rotatable about a common rotary shaft. The diaphragm can be arranged in a confocal scanning microscope.

This application claims priority to German utility model application 202 05 079.3, which is hereby incorporated by reference herein.

### FIELD OF THE INVENTION

The invention concerns a variable diaphragm having two diaphragm blades movable relative to one another.

The invention furthermore concerns a confocal scanning microscope having a variable diaphragm having two diaphragm blades movable relative to one another.

### BACKGROUND OF THE INVENTION

Variable diaphragms are known in optics in many embodiments. The simplest that may be cited is the diaphragm disk, in which multiple diaphragms having different openings are mounted on a rotatable disk and can be introduced into a beam path. A continuous modification of the diaphragm opening is not possible with diaphragm disks.

The aperture of iris diaphragms is continuously adjustable. Iris diaphragms have a very complex structure, however, and are therefore not advisable for use for applications that require apertures in the sub-millimeter range, for example in confocal microscopy.

For small apertures in particular, cat's-eye diaphragms (also known as Aubert diaphragms) are particularly suitable. In this type of diaphragm, two sliders that are linearly movable in opposite directions are shaped so that they form a rectangular, generally square, aperture whose size changes as the sliders move. Cat's-eye diaphragms can be manufactured with very high accuracy, the manufacture of a precise guidance system for the sliders being complex especially when it is necessary to ensure that the center of the diaphragm opening remains stationary as the aperture is varied.

German Application DE 199 02 624 A1 discloses an optical arrangement for spectral spreading of a light beam that is usable in particular in confocal microscopy. The optical arrangement is characterized in that it has a polygonal passthrough. This has a very advantageous effect on the spectral resolution capability.

In scanning microscopy, a specimen is illuminated with a light beam in order to observe the reflected or fluorescent light emitted from the specimen. The focus of an illuminating light beam is moved in a specimen plane by means of a controllable beam deflection device, generally by tilting two mirrors; the deflection axes are usually perpendicular to one another, so that one mirror deflects in the X direction and the other in the Y direction. Tilting of the mirrors is brought about, for example, by means of galvanometer positioning elements. The power level of the light coming from the specimen is measured as a function of the position of the scanning beam. The positioning elements are usually equipped with sensors to ascertain the present mirror position.

In confocal scanning microscopy specifically, a specimen is scanned in three dimensions with the focus of a light beam.

A confocal scanning microscope generally comprises a light source, a focusing optical system with which the light of the source is focused onto a diaphragm (called the “excitation pinhole”), a beam splitter, a beam deflection device for beam control, a microscope optical system, a detection pinhole, and the detectors for detecting the detected or fluorescent light. The illuminating light is coupled in via a beam splitter. The fluorescent or reflected light coming from the specimen travels back through the beam deflection device to the beam splitter, passes through it, and is then focused onto the detection pinhole behind which the detectors are located. Detected light that does not derive directly from the focus region takes a different light path and does not pass through the detection pinhole, so that a point datum is obtained which results, by sequential scanning of the specimen, in a three-dimensional image. A three-dimensional image is usually achieved by acquiring image data in layers, the track of the scanning light beam on or in the specimen ideally describing a meander (scanning one line in the X direction at a constant Y position, then stopping the X scan and slewing by Y displacement to the next line to be scanned, then scanning that line in the negative X direction at constant Y position, etc.). To allow image data acquisition in layers, the specimen stage or the objective is displaced after a layer has been scanned, and the next layer to be scanned is thus brought into the focal plane of the objective.

### SUMMARY OF THE INVENTION

It is therefore an object of the invention to provide a diaphragm that, with a simple design, is precisely adjustable in particular to small apertures, and at the same time is compact.

The invention provides a diaphragm wherein the diaphragm blades are rotatable about a common rotary shaft.

A further object of the invention is to describe a confocal scanning microscope that permits an increased and precise depth discrimination and at the same time can be economically manufactured with a compact configuration.

The invention provides a confocal scanning microscope having at least one variable diaphragm, wherein the diaphragm blades are rotatable about a common rotary shaft.

The invention has the advantage that it makes possible, with very high optical accuracy, a flat and compact configuration which is the basic prerequisite for short, easily alignable beam paths.

The diaphragm blades have a common rotary shaft about which they are individually and simultaneously rotatable in opposite directions in a scissor-like motion.

In a preferred embodiment, the diaphragm blades, similarly to a cat's-eye diaphragm, have one notch, each which together define a passthrough opening. The spacing of the notches from the rotary shaft is advantageously sufficient that the tilting of the notches upon modification of the aperture has no appreciable influence on the aperture shape.

The notches are preferably V-shaped in order to produce a rectangular aperture shape. If only one diaphragm blade is notched, a triangular diaphragm opening is obtained.

In a preferred embodiment, the diaphragm blades are made of thin panels arranged one above another.

In a particularly preferred embodiment, at least one diaphragm blade has a guide notch, lying in the rotation plane, into which a drive pin engages. In a very particularly preferred embodiment, the diaphragm blades have guide notches arranged mirror-symmetrically with respect to one another, into which a single drive pin engages.

In an advantageous embodiment, the diaphragm blades are motor-driven. An embodiment in which the two diaphragm blades have a common motorized drive system is particularly advantageous. The motorized drive system is embodied, for example, as a linear drive system that moves the two diaphragm blades by way of a pusher bar on which the drive pin is mounted.

In another embodiment, a drive system by way of an eccentric cam is provided. Other types of drive system are possible, it being important that the middle of the aperture remain as accurately as possible in the center upon adjustment, and that advantageously, a reduction ratio from the drive system to the aperture size be present in some form (for example by way of lever ratios or thread pitch) in order to achieve adjustment accuracies in the micrometer range.

Use of the diaphragm in a confocal scanning microscope is very particularly advantageous. In a preferred embodiment, the diaphragm according to the present invention constitutes the detection pinhole; and optionally a further diaphragm according to the present invention constitutes the illumination pinhole.

### BRIEF DESCRIPTION OF THE DRAWINGS

The subject matter of the invention is depicted schematically in the drawings and will be described below with reference to the Figures, identically functioning elements being labeled with the same reference characters. In the drawings:

FIG. 1 shows a diaphragm according to the present invention;

FIG. 2 shows a diaphragm blade of a diaphragm according to the present invention;

FIG. 3 shows a scanning microscope according to the present invention.

### DETAILED DESCRIPTION OF THE INVENTION

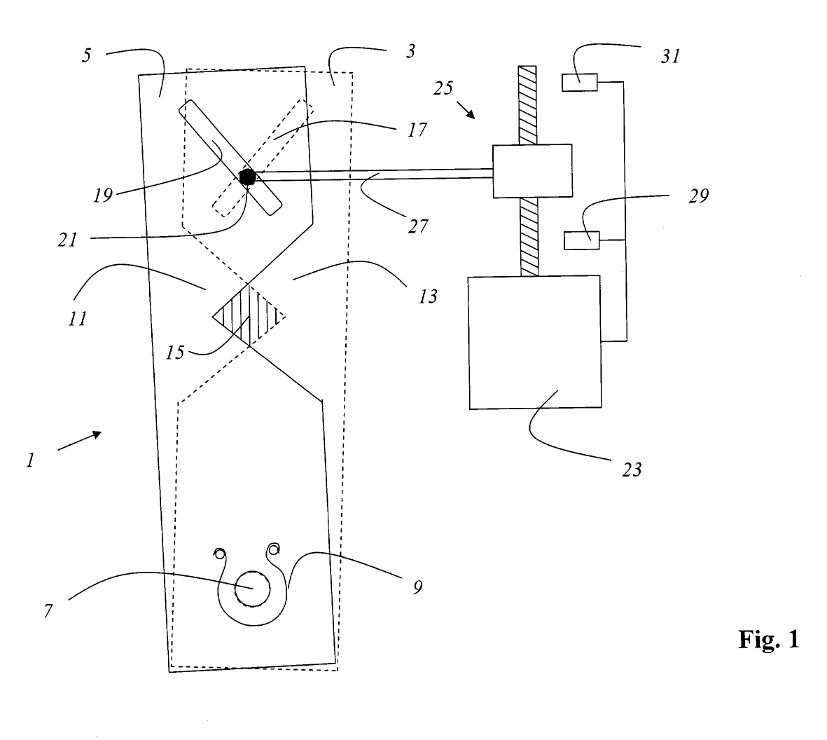

FIG. 1 shows a motor-driven diaphragm 1 according to the present invention that contains a first diaphragm blade 3 and a second diaphragm blade 5 that are arranged rotatably with respect to one another about a rotary shaft 7. To achieve a precise rotary motion of diaphragm blades 3, 5, a precision plain bearing (not shown) is provided. Diaphragm blades 3, 5 are pressed apart by a spring 9. First diaphragm blade 3 has a first V-shaped notch 11. Second diaphragm blade 5 has a second V-shaped notch 13. Notches 11, 13 form aperture 15, which is depicted with cross-hatching. First diaphragm blade 3 has a first guide slot 17; second diaphragm blade 5 has a second guide slot 19; engaging into the two guide slots, which are arranged mirror-symmetrically with respect to one another, is a drive pin 21 that is driven by a motor 23 via a spindle drive 25 and a linkage 27 and that moves the two diaphragm blades 3, 5 in opposite directions rotationally about rotary shaft 7. Two limit switches 29, 31, which limit the travel of spindle drive 25 and are embodied as photoelectric barrier switches, are provided in order to prevent damage.

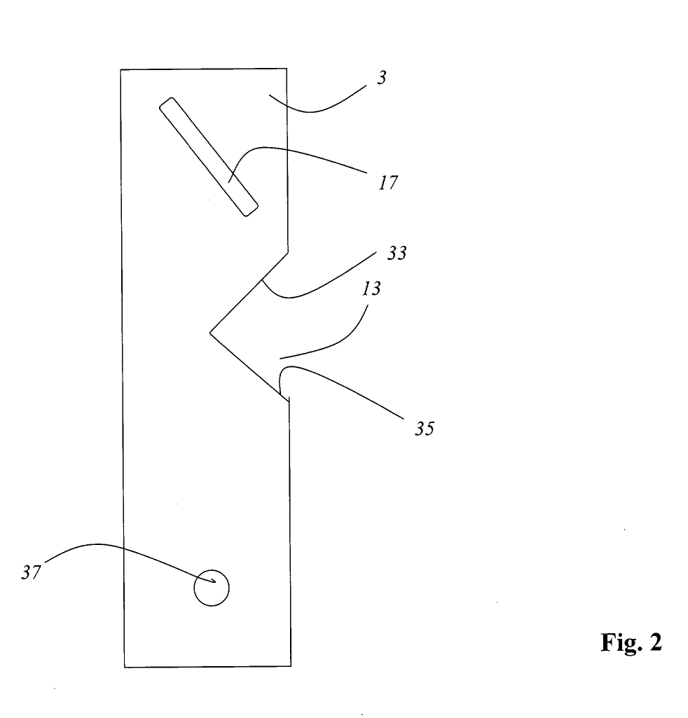

FIG. 2 shows a diaphragm blade 3 of a diaphragm according to the present invention in an individual view. Diaphragm blade 3 has a guide slot 17 and an opening 37 for rotatable mounting on a rotary shaft via a bearing. Diaphragm blade 3 furthermore has a notch 13 whose edges 33, 35 are manufactured with high accuracy by etching.

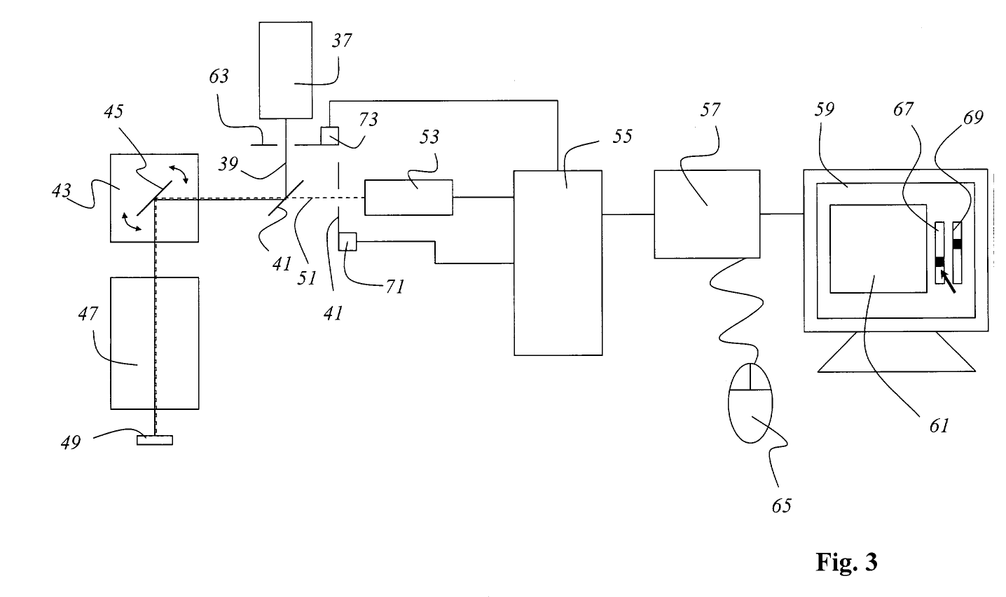

FIG. 3 schematically shows a confocal scanning microscope. Light beam 39 coming from an illumination system 37 is reflected by a beam splitter 41 to scanning module 43, which contains a gimbal-mounted scanning mirror 45 that guides the beam through microscope optical system 47 over or through specimen 49. In the case of non-transparent specimens 49, light beam 39 is guided over the specimen surface. With biological specimens 49 (preparations) or transparent specimens, light beam 39 can also be guided through specimen 49. This means that different focal planes of the specimen are successively scanned by light beam 39. Subsequent assembly then yields a three-dimensional image of specimen 49. Light beam 39 coming from illumination system 37 is depicted as a solid line. Light 51 proceeding from specimen 49 travels through microscope optical system 47 and via scanning module 43 to beam splitter 41, passes through the latter and strikes detector 53, which is embodied as a photomultiplier. Light 51 proceeding from specimen 49 is depicted as a dashed line. In detector 53, electrical detected signals proportional to the power level of light 51 proceeding from the specimen are generated and forwarded to processing unit 55. The processed image data are displayed by way of a PC 57 on a monitor 59 as image 61. The variable illumination pinhole 63 and detection pinhole 65 usually provided in a confocal scanning microscope are embodied, according to the present invention, as variable diaphragms having two rotatably mounted diaphragm blades, and are driven by two motors 71, 73. The apertures of detection pinhole 65 and of illumination pinhole 63 can be adjusted by the user by way of PC 57, to which an input unit 65 is connected, and processing unit 55. A first and a second slider 67 and 69, with which the user makes the inputs, are displayed on a monitor 59. The user can see the results of adjusting sliders 67, 69 in real time on image 61.

The invention has been described with reference to a particular exemplary embodiment. It is self-evident, however, that changes and modifications can be made without thereby leaving the range of protection of the claims below.

What is claimed is:

1. A variable diaphragm having two diaphragm blades movable relative to one another, wherein the diaphragm blades are rotatable about a common rotary shaft.

2. The variable diaphragm as defined in claim 1, wherein the diaphragm blades have one notch each which together define a passthrough opening.

3. The variable diaphragm as defined in claim 2, wherein at least one of the notches is V-shaped.

4. The variable diaphragm as defined in claim 1, wherein the diaphragm blades are simultaneously rotatable in opposite directions.

5. The variable diaphragm as defined in defined in claim 1, wherein the diaphragm blades are arranged one above another.

6. The variable diaphragm as defined in claim 1, wherein at least one diaphragm blade has a guide notch, lying in the rotation plane, into which a drive pin engages.

7. The variable diaphragm as defined in claim 6, wherein the diaphragm blades have guide notches arranged mirror-symmetrically with respect to one another, into which a single drive pin engages.

8. The variable diaphragm as defined in claim 1, wherein the diaphragm blades are motor-driven.

9. The variable diaphragm as defined in claim 1, wherein the diaphragm blades have a common motorized drive system.

10. A confocal scanning microscope having at least one variable diaphragm having two diaphragm blades movable relative to one another, wherein the diaphragm blades are rotatable about a common rotary shaft.

11. The confocal scanning microscope as defined in claim 10, wherein the diaphragm blades have one notch each which together define a passthrough opening.

12. The confocal scanning microscope as defined in claim 11, wherein at least one of the notches is V-shaped.

13. The confocal scanning microscope as defined in claim 10, wherein the diaphragm blades are simultaneously rotatable in opposite directions.

14. The confocal scanning microscope as defined in claim 10, wherein the diaphragm blades are arranged one above another.

15. The confocal scanning microscope as defined in claim 10, wherein at least one diaphragm blade has a guide notch, lying in the rotation plane, into which a drive pin engages.

16. The confocal scanning microscope as defined in claim 15, wherein the diaphragm blades have guide notches arranged mirror-symmetrically with respect to one another, into which a single drive pin engages.

17. The confocal scanning microscope as defined in claim 10, wherein the diaphragm blades are motor-driven.

18. The confocal scanning microscope as defined in claim 10, wherein the diaphragm blades have a common motorized drive system.

19. The confocal scanning microscope as defined in claim 10, wherein the diaphragm is a detection pinhole.

20. The confocal scanning microscope as defined in claim 10, wherein the diaphragm is an illumination pinhole.
